(19) United States
(12) Patent Application Publication
(10) Pub. No.: US 2019/0208590 A1
(43) Pub. Date: Jul. 4, 2019

(54) LIGHT-EMITTING DIODE LIGHTING SYSTEM WITH DIMMING FUNCTION

(71) Applicant: Sze Yam Kan, Hong Kong (HK)

(72) Inventors: Chuen Chiu Lau, Hong Kong (HK); Sze Yam Kan, Hong Kong (HK)

(21) Appl. No.: 16/186,613

(22) Filed: Nov. 12, 2018

(30) Foreign Application Priority Data
Dec. 29, 2017 (CN) 201711490261.6

(51) Int. Cl. H05B 33/08

(52) U.S. Cl. CPC H05B 33/0809; H05B 33/0845; H05B 33/0821

(57) ABSTRACT

An LED lighting system with dimming function is disclosed. The LED lighting system includes an external power supply, a primary switch, a toroidal transformer, and an LED lamp, which are all connected in order. The toroidal transformer has a plurality of groups of input ends and at least one group of output ends. The toroidal transformer and the LED lamp are respective independent devices. The external power supply is switchably connected to one group of the plurality of groups of input ends of the toroidal transformer through the primary switch. Each group of input ends of the toroidal transformer has different configured voltages that generate different output voltages at the output ends of the toroidal transformer. The output ends of the toroidal transformer are connected to the LED lamp. The brightness of the LED lamp can be easily adjusted by the system.

### CROSS REFERENCE TO RELATED APPLICATIONS

The present application claims the benefit of Chinese Patent Application No. 201711490261.6 filed on Dec. 29, 2017, the contents of which are incorporated herein by reference in its entirety.

### TECHNICAL FIELD

The present disclosure relates to light-emitting diodes, and more particularly to a light-emitting diode lighting system having dimming function.

### BACKGROUND

Light-emitting diode (LED) is made of a single PN structure. It is a device with unidirectional conductivity. Light-emitting diode driver circuit is used to make the light-emitting diode circuit glow. Light-emitting diodes are traditionally defined as low-voltage direct current products.

With the widespread use of LED lighting system, people are gradually concerned about the problem of dimming an LED lamp. In many applications, dimming is very important because it allows customers to set the required brightness according to actual needs. Customers not only can have a better lighting experience, they can also use energy more efficiently. From the customer's point of view, it can also avoid unnecessary electricity cost. FIG. 1 shows a typical dimming circuit. It can be seen that it includes diodes, capacitors, inductors, chips and other electronic components. The dimming circuit is more complex, and the cost is higher.

### SUMMARY

The present disclosure provides a light-emitting diode (LED) lighting system with dimming function, the LED lighting system including an external power supply; a primary switch; a toroidal transformer; and an LED lamp, which are all connected in order. The toroidal transformer has a plurality of groups of input ends and at least one group of output ends. The toroidal transformer and the LED lamp are respective independent devices. The external power supply is switchably connected to one group of the plurality of groups of input ends of the toroidal transformer through the primary switch. Each group of input ends of the toroidal transformer has different configured voltages that generate different output voltages at the output ends of the toroidal transformer. The output ends of the toroidal transformer are connected to the LED lamp.

In an embodiment, the LED lamp is a direct current lamp or an alternating current lamp.

In an embodiment, the alternating current lamp includes at least one light-emitting diode circuit, the light-emitting diode circuit at least includes two light-emitting diode branches, and the two light-emitting diode branches are connected in parallel and same direction.

In an embodiment, each of the light-emitting diode branches includes a plurality of light-emitting diodes connected in series and same direction.

In an embodiment, the alternating current lamp further includes a rectifier circuit connected between the output ends of the toroidal transformer and the light-emitting diode circuit.

In an embodiment, the rectifier circuit is a bridge rectifier circuit, and the four diodes of the bridge rectifier circuit are all light-emitting diodes.

In an embodiment, the lighting system further includes a secondary dimming circuit connected between the output ends of the toroidal transformer and the LED lamp.

In an embodiment, the secondary dimming circuit includes a diode step-down circuit and a secondary switch, an input end of the diode step-down circuit is connected with the output ends of the toroidal transformer, an output end of the diode step-down circuit is connected to one end of the secondary switch, and another end of the secondary switch is connected to the LED lamp.

In an embodiment, the diode step-down circuit includes a plurality of inverse-parallel diode circuits connected in series, and each inverse-parallel diode circuit is provided with a voltage output end connected to the secondary switch.

In an embodiment, each inverse-parallel diode circuit includes a forward diode and a reverse diode connected in parallel.

In the LED lighting system of the present disclosure, the LED lighting can be dimmed by a toroidal transformer. Its dimming method is simple, and the entire lighting system has an excellent cost benefit.

### BRIEF DESCRIPTION OF THE DRAWINGS

FIG. 1 is a dimming circuit of the prior art;

FIG. 2 is an overall structure of a dimming circuit system according to a first embodiment of the present disclosure;

FIG. 3 is a dimming circuit diagram of the first embodiment of the present disclosure;

FIG. 4 is an internal structure of the LED lamp of the first embodiment of the present disclosure;

FIG. 5 is a dimming circuit diagram according to a second embodiment of the present disclosure;

FIG. 6 is another dimming circuit diagram of the second embodiment of the present disclosure.

### DETAILED DESCRIPTION

The present disclosure will be further described in detail below with reference to the accompanying drawings.

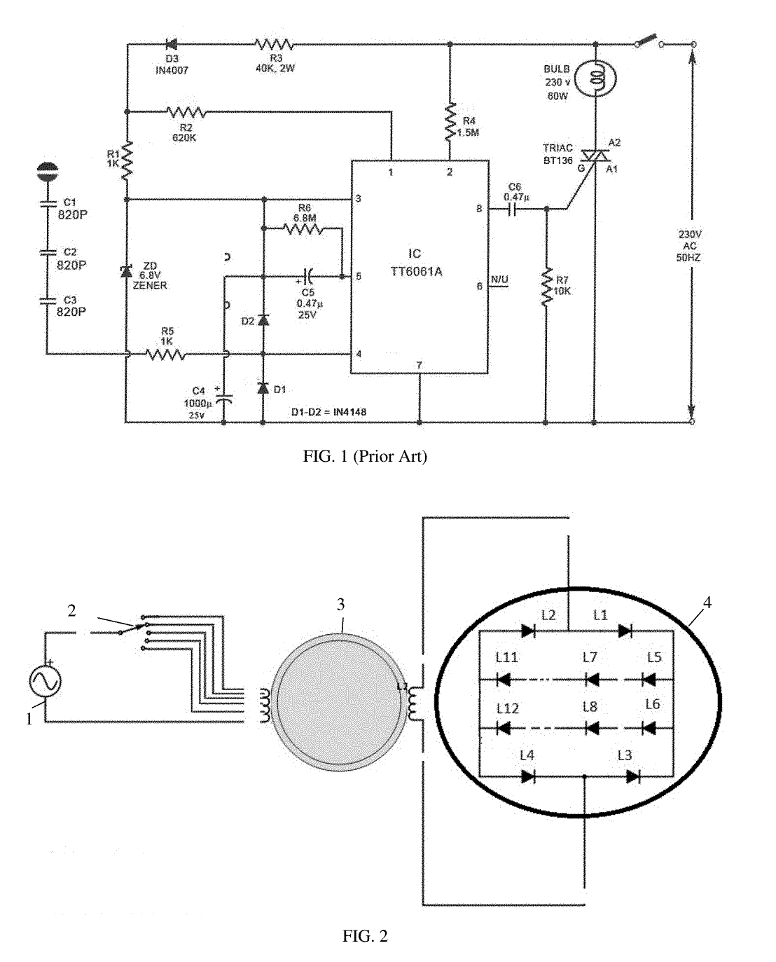

The LED lighting system with dimming function according to the embodiments of the present disclosure are shown in FIGS. 2-6. In the present disclosure, the dimming for the LED lighting system can be divided into two types. One is called primary dimming, and the other is called secondary dimming. The two types of dimming are described below.

As shown in FIGS. 2-4, the primary dimming LED lighting system according to the first embodiment of the present disclosure may include an external power supply 1, a primary switch 2, a toroidal transformer 3, and an LED lamp 4, which are all connected in order. The external power supply 1 can provide the LED lighting system with working power. For example, it can be a power supply of 220 v/50 Hz. Obviously, power supply having other voltage and frequency is also feasible.

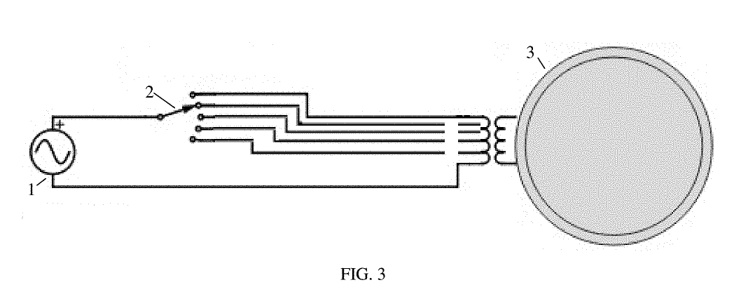

In the LED lighting system of the embodiment of the present disclosure, the toroidal transformer 3 may be used to adjust the voltage of the AC (alternating current) power supply to obtain a voltage suitable for the operation of the LED. As shown in the figures, the toroidal transformer 3 may have at least one group of input ends and at least one group of output ends. Referring to FIGS. 2 and 3, the toroidal transformer 3 may have a plurality of groups of input ends. The power supply 1 can be switchably connected to one group of the plurality of groups of input ends of the toroidal transformer 3 via the primary switch 2. The primary switch 2 can be used for switching the plurality of groups of input ends of the toroidal transformer 3. An input end of the primary switch 2 may be connected to the external AC power supply 1. Output ends of the primary switch 2 can be switchably connected to one group of the plurality of groups of input ends of the toroidal transformer 3.

Illustratively, as shown in FIGS. 2 and 3, the toroidal transformer 3 may be provided with five groups of input ends. The five groups of input ends can be tapped at different coil positions in the primary winding of the toroidal transformer. Thus, corresponding to different primary winding lengths, different output voltages can be induced in the same secondary winding.

Taking AC power supply of 220 v and five groups of input ends that respectively correspond to configured voltages of 200 v, 210 v, 220 v, 230 v, 240 v as an example, a configured voltage at an input end means that when the input end inputs a configured voltage, the output end can obtain a corresponding standard configured output voltage, e.g. 6 volts. That is, when an external power supply 1 having a voltage of 220 v is input from an input end having a configured voltage of 220 v, the output end results in a standard configured output voltage of 6 volts. If a voltage of 220 v is input from an input end having a configured voltage of 210 v, the corresponding output voltage is higher than the standard configured output voltage (6 volts) because the input voltage is higher than the configured voltage at that input end. If a voltage of 220 v is input from an input end having a configured voltage of 230 v, the corresponding output voltage is lower than the standard configured output voltage (6 volts) because the input voltage is lower than the configured voltage at that input end. Further, assuming that when the output voltage of the toroidal transformer is 6 volts, the brightness of the light-emitting diode is a standard brightness. When AC power of 220 v is connected to the input end having a configured voltage of 220 v through a switch circuit, the light-emitting diode has a standard brightness. When AC power of 220 v is connected to input ends having configured voltages of 200 v and 210 v through switching of the primary switch 2, the light-emitting diode is brighter. When AC power of 220 v is connected to input ends having configured voltages of 230 v and 240 v through switching of the primary switch 2, the light-emitting diode is dimmer. Therefore, although the external AC power remains unchanged at 220 v, the toroidal transformer 3 can output different voltages when the input of the toroidal transformer 3 is switched through the primary switch 2. Thus, the brightness of the LED lamp 4 can be adjusted accordingly.

It should be noted that the above electrical parameters, i.e. the output voltage of the AC power source externally connected to the switch circuit, the configured voltage of the input ends of the toroidal transformer 3, etc. are all specific embodiments. In practical application, they can be adjusted accordingly. For example, there may be three groups, four groups, or any number of groups of input ends. The configured voltage of each input end can also be arbitrarily configured as needed.

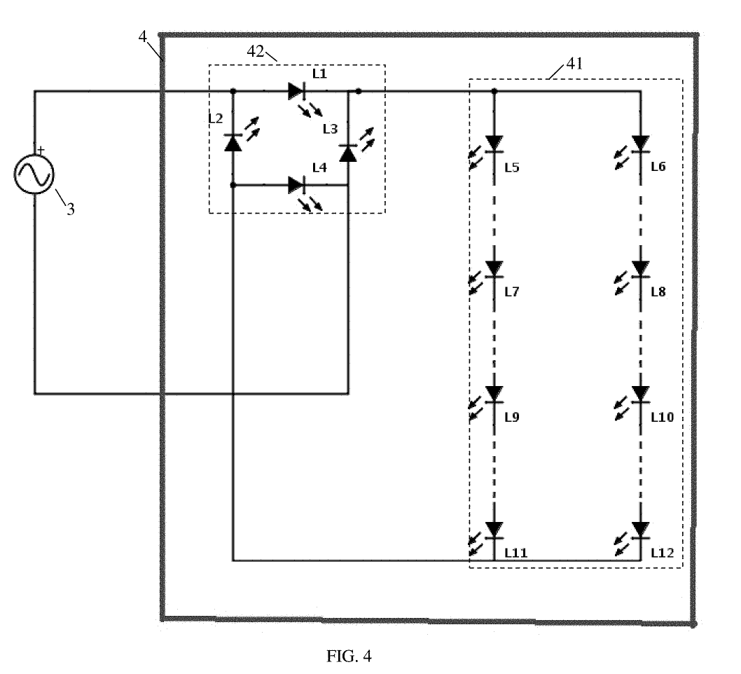

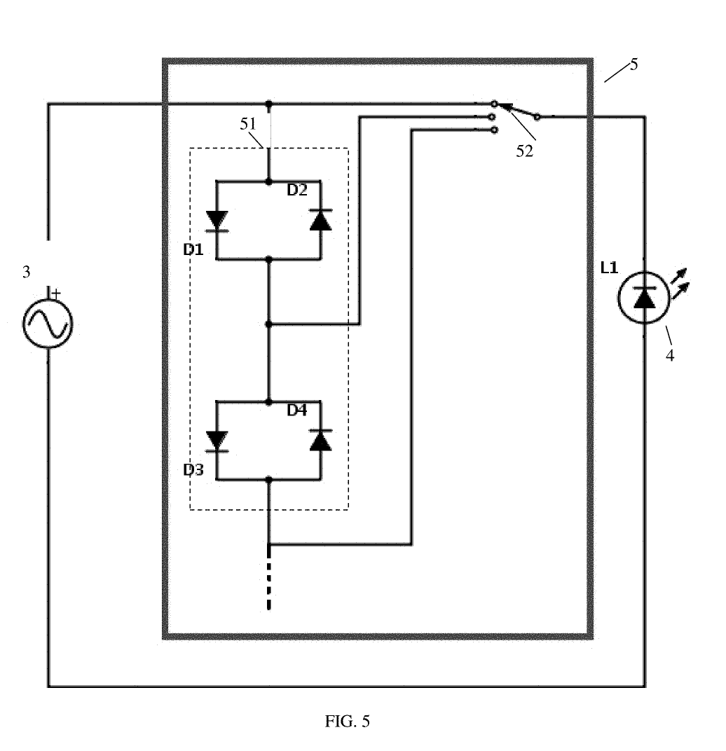

In the present disclosure, the LED lamp 4 may be a DC (direct current) lamp, i.e. it needs an external DC power supply. It can also be an AC lamp, i.e. it can be directly connected to a low voltage AC power supply. As shown in FIG. 4, the AC LED lamp 4 can be connected to a low voltage output by the toroidal transformer, such as an AC voltage of 6 volts. The AC LED lamp 4 may include at least one LED circuit 41. The LED circuit 41 may include a parallel same direction light-emitting diode circuit. A parallel same direction light-emitting diode circuit refers to a circuit which includes at least two light-emitting diodes connected in parallel and same direction. That is, the circuit may include at least two light-emitting diode branches. The two light-emitting diode branches may be connected in parallel. Each branch may have one light-emitting diode. The two light-emitting diodes on the two branches may be disposed in the same direction. That is to say, the anode and the cathode of the light-emitting diode on one branch may be respectively connected with the anode and the cathode of the light-emitting diode on the other branch. In addition, each light-emitting diode parallel branch in the parallel same direction light-emitting diode circuit may also include a plurality of light-emitting diodes connected in series and same direction. For example, four light-emitting diodes in the same direction may be connected in series, so that a parallel same direction light-emitting diode circuit may include eight light-emitting diodes. As shown in FIG. 4, the first light-emitting diode parallel branch may include light emitting diodes L5, L7, L9 and L11 connected in series and same direction, and the second light-emitting diode parallel branch may include light emitting diodes L6, L8, L10 and L12 connected in series and same direction.

As an AC-type lamp, the LED lamp may further include a rectifier circuit 42 connected between the output ends of the toroidal transformer 3 and the light-emitting diode circuit 41. For example, a bridge rectifier circuit may be used. An input end of the bridge rectifier circuit may be connected to an output end of the toroidal transformer 3. An output end of the bridge rectifier circuit may be connected to an input end of the light-emitting diode circuit 41.

In practical industrial applications, the LED lamp 4 may exist as an independent component so that it can be directly connected to the toroidal transformer 3. On the other hand, for a DC-type lamp, a rectifier circuit can be added between the toroidal transformer and the lamp. That is, the rectifier circuit is not integrated inside the lamp 4 as shown in FIG. 4, but it is a separate circuit outside the lamp 4. However, whether it is an AC-type lamp or a DC-type lamp, it can be connected to the output end of the toroidal transformer 3 without the need of modifying the circuit of the entire lighting system except for the LED lamps 4. This can facilitate the construction of the entire lighting system. In other words, in the entire system with the LED lamp 4 as a separate device and the toroidal transformer 3 as another separate device, the output end of the toroidal transformer 3 can be directly connected to the input end of the LED lamp 4 during construction of the lighting system. Hence, the construction of the lighting system can be very easy.

In addition, as shown in FIG. 4, the four diodes in the bridge rectifier circuit can also be entirely light-emitting diodes, thereby forming a lamp with only light-emitting diodes. That is, the diodes in the bridge rectifier circuit can play the role of rectifying and lighting at the same time. The entire lamp 4 constitutes a full LED-type lamp.

Toroidal transformers are normally used in household appliances and other electronic equipment that have higher technical requirements. Toroidal transformers may be made by winding copper coils around toroidal iron cores. The toroidal iron core of a toroidal transformer is usually made by seamless rolling of a high-quality, cold-rolled silicon steel sheet. The toroidal iron core of the toroidal transformer is evenly wound around the iron core. The direction of magnetic lines of force generated by the coil almost completely coincides with the magnetic path of the iron core. It has high electric efficiency and small no-load current. Toroidal transformers have small size, light weight, less magnetic interference, low operating temperature, and are easy to install. The light-emitting diode lighting system according to the embodiments of the present disclosure can achieve the following beneficial effects:

1. Energy Efficiency: A toroidal transformer can reduce energy consumption. Its consumption rate is less than about 3%. Compared to DC light-emitting diode that uses a driver, it can save about 15% of energy. Compared to traditional MR16, it can save up to 70% of energy.

2. Environmental benefit: In addition to light-emitting diode (LED), the toroidal transformer has environmental benefit. Its main raw materials are copper wire and iron core or silicon steel sheet. Its re-use rate can be as high as 70%. Compared to the process of handling lamp disposal, obviously it can greatly reduce waste disposal. It can save a lot of manpower and resources, and is beneficial to environmental protection.

3. Economic Benefit: Making use of multiple output concept, a toroidal transformer can drive multiple LEDs at the same time. This can apply to lamps with more output and higher power. The greater the number of LEDs is to be driven, the lower the cost is. Using 20 as an example, its economic benefit is greater than 20 independent drivers of the same level of design.

4. Toroidal transformers have long life under normal use. They are particularly suitable in places where replacement of lamps is difficult. They can greatly reduce frequency of replacement and maintenance workload.

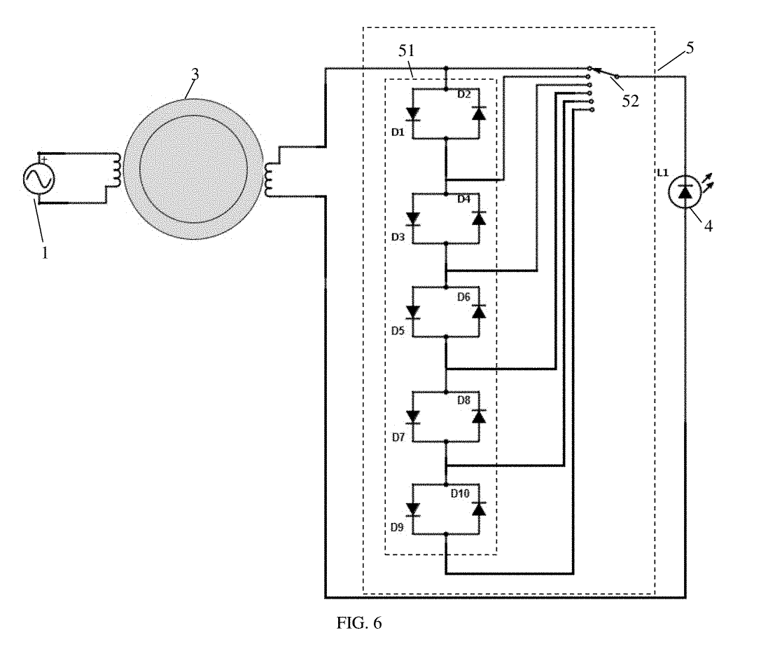

Referring to FIG. 5 and FIG. 6, the secondary dimming LED lighting system according to the second embodiment of the present disclosure may include a secondary dimming circuit 5 connected between the output end (secondary winding) of the toroidal transformer 3 and the LED lamp 4. The secondary dimming circuit may include a diode step-down circuit 51 and a secondary switch 52. An input end of the diode step-down circuit 51 may be connected to the secondary winding of the toroidal transformer 3. One end of the secondary switch 52 may be connected to an output end of the diode step-down circuit, and the other end of the secondary switch 52 may be connected to the LED lamp 4.

The diode step-down circuit 51 may include a plurality of inverse-parallel diode circuits connected in series. An inverse-parallel diode circuit, is a circuit which includes at least two inverse-parallel diodes. That is, the circuit may include at least two diode branches. The two diode branches may be connected in parallel. Each branch may have one diode. The two diodes on the two branches may be inversely connected. That is to say, the anode and the cathode of the diode of one branch may be respectively connected with the anode and the cathode of the diode of the other branch. Each inverse-parallel diode circuit may be provided with a voltage output connector, which may be connected to the secondary switch 52. FIG. 5 shows two inverse-parallel diode circuits, which can provide three output voltages. FIG. 6 shows four inverse-parallel diode circuits, which can provide four output voltages. Since the diode has its own on-state voltage, it is equivalent to a reduction of the on-stage voltage of the diode after going through the diode. Therefore, it is possible to provide different output voltages before passing through an inverse-parallel diode circuit as shown in the figure, and after passing through an inverse-parallel diode circuit as shown in the figure. Different output voltages acting on the LED lamp 4 can result in different brightness. Thus, by switching the secondary switch 52 between different contacts, different output voltages can be provided so that the LED lamp 4 can have a corresponding brightness.

As described above, by means of the on-stage voltage of the forward diode in the inverse-parallel diode circuit in the diode step-down voltage 51, dimming function of the secondary dimming circuit 5 can be provided. The reverse diode in each inverse-parallel diode circuit can provide voltage protection function accordingly.

In the present disclosure, the diode step-down circuit can be used to switch different numbers of forward diodes to the circuit connection through the secondary switch. This makes the output voltage produce different voltage reduction in accordance with the number of different forward diodes in order to achieve the effect of adjusting brightness of the LED lamps. The dimming method is easy, and the circuit structure is simple.

The foregoing is a further detailed description of the present disclosure in conjunction with certain specific embodiments. The specific embodiments of the present disclosure cannot be regarded as being limited to the description. For those of ordinary skill in the art to which the present disclosure pertains, it is possible to make some simple derivation or replacement without departing from the concept of the present disclosure, which should be regarded as belonging to the protection scope of the present disclosure.

What is claimed is:

1. A light-emitting diode (LED) lighting system with dimming function, the LED lighting system comprising an external power supply; a primary switch; a toroidal transformer; and an LED lamp, which are all connected in order, wherein the toroidal transformer comprises a plurality of groups of input ends and at least one group of output ends, the toroidal transformer and the LED lamp are respective independent devices, the external power supply is switchably connected to one group of the plurality of groups of input ends of the toroidal transformer through the primary switch, each group of input ends of the toroidal transformer has different configured voltages that generate different output voltages at the output ends of the toroidal transformer, and the output ends of the toroidal transformer are connected to the LED lamp.

2. The LED lighting system according to claim 1, wherein the LED lamp is a direct current lamp or an alternating current lamp.

3. The LED lighting system according to claim 2, wherein the alternating current lamp comprises at least one light-emitting diode circuit, the light-emitting diode circuit at least comprises two light-emitting diode branches, and the two light-emitting diode branches are connected in parallel and same direction.

4. The LED lighting system according to claim 3, wherein each of the light-emitting diode branches comprises a plurality of light-emitting diodes connected in series and same direction.

5. The LED lighting system according to claim 3, wherein the alternating current lamp further comprises a rectifier circuit connected between the output ends of the toroidal transformer and the light-emitting diode circuit.

6. The LED lighting system according to claim 5, wherein the rectifier circuit is a bridge rectifier circuit, and four diodes of the bridge rectifier circuit are all light-emitting diodes.

7. The LED lighting system of claim 1, wherein the lighting system further comprises a secondary dimming circuit connected between the output ends of the toroidal transformer and the LED lamp.

8. The LED lighting system according to claim 7, wherein the secondary dimming circuit comprises a diode step-down circuit and a secondary switch, an input end of the diode step-down circuit is connected with the output ends of the toroidal transformer, an output end of the diode step-down circuit is connected to one end of the secondary switch, and another end of the secondary switch is connected to the LED lamp.

9. The LED lighting system according to claim 8, wherein the diode step-down circuit comprises a plurality of inverse-parallel diode circuits connected in series, and each inverse-parallel diode circuit is provided with a voltage output end connected to the secondary switch.

10. The LED lighting system according to claim 9, wherein each inverse-parallel diode circuit comprises a forward diode and a reverse diode connected in parallel.
